(19) United States
(12) Patent Application Publication
(10) Pub. No.: US 2023/0196235 A1
(43) Pub. Date: Jun. 22, 2023

(54) SYSTEMS AND METHODS FOR PROVIDING MACHINE LEARNING OF BUSINESS OPERATIONS AND GENERATING RECOMMENDATIONS OR ACTIONABLE INSIGHTS

(71) Applicants: Vehbi Deger Turan, San Francisco, CA (US); Gregory Renard, REDWOOD CITY, CA (US); Arda Keskiner, Berlin (DE); Ceyda Dirin, Izmir (TR); Tanay Kothari, San Francisco, CA (US)

(72) Inventors: Vehbi Deger Turan, San Francisco, CA (US); Gregory Renard, REDWOOD CITY, CA (US); Arda Keskiner, Berlin (DE); Ceyda Dirin, Izmir (TR); Tanay Kothari, San Francisco, CA (US)

(21) Appl. No.: 17/553,743

(22) Filed: Dec. 16, 2021

(51) Int. Cl. G06Q 10/06; G06Q 30/02; G06N 5/04

(52) U.S. Cl. CPC G06Q 10/06315; G06Q 10/06375; G06Q 30/0201; G06N 5/04

(57) ABSTRACT

An exemplary system that provides automated business intelligence from business data to improve operations of the business is disclosed. The system extracts signals from any unstructured data source. The system identifies anomalies in customer data and global trends for retail companies that present opportunities and crises to avoid and suggests optimal courses of action and estimated financial impact. The system also alerts individuals with opportunities and predicts customers' needs. The system extracts signals from any data source, structured or not, to alert the user of opportunities and anticipate customers' needs. The system determines the trends, what products are hits, the opportunities to pursue, and when to reach out to customers. This is done by collecting data from a multi-source data collection system.

This application claims priority to application Ser. No. ______ entitled “SYSTEMS AND METHODS FOR LINKING A PRODUCT TO EXTERNAL CONTENT” and application Ser. No. ______ entitled “SYSTEMS AND METHODS FOR ANALYZING CUSTOMER REVIEWS”, both of which are filed concurrently herewith and the contents of which are incorporated by reference.

### BACKGROUND

The present invention relates to machine learning of business operation parameters and management thereof.

Decision making can be difficult for reasons ranging from vague reporting structures to the complexities that naturally arise when an organization matures, and more decisions and decision makers are involved. The result is often wasted time, confusion, and frustration. Individually, everyone's intentions are good, yet the whole performs poorly. To counter the growth in information indigestion, management software such as executive information systems (EIS), group decision support systems (GDSS), and organizational decision support systems (ODSS) have been developed to help organizations to focus on data-driven decision making.

A decision support system (DSS) is a computerized program used to support determinations, judgments, and courses of action in an organization or a business. A DSS sifts through and analyzes massive amounts of data, compiling comprehensive information that can be used to solve problems and in decision-making. The DSS can help decision makers use communications technologies, data, documents, knowledge and/or models to complete decision process tasks. The DSS is a class of computerized information system that support decision-making activities. Historically, the DSS is run by analysts who collect and massage the data before generating reports for management.

### SUMMARY

Systems and methods are disclosed for automated business intelligence from business data to improve operations of the business. The system extracts signals from any unstructured data source. The system identifies anomalies in customer data and global trends for retail companies that present opportunities and crises to avoid and suggests optimal courses of action and estimated financial impact. The system also alerts individuals with opportunities and predicts customers' needs.

Advantages of the system may include one or more of the following. The system enables users to understand what customers are thinking by extracting insights from any open-ended text, including chat logs, product reviews, transcripts, and more. The system enables users to perform Data-Driven Merchandising, for example, to answer which product attributes are most likely to surge and underperform in the next season, and why? The system also enables users to identify Marketing ROI and answer questions such as “what are the products and customer segments that would benefit the most from marketing, and what are the right assortments to highlight?” The system enables users to identify the buying process that aligns the voice of the customer with the needs of the enterprise. Customer Experience is improved, and new needs can be anticipated. The system further identifies customer segment churns and how to re-engage customers. The system enables users to perform Dynamic Markdown—which items should be put on clearance? If so, when and by how much? In other uses, the system excels in finding behavioral patterns and early signals of surges and declines, from any data source. Combining signals from text reviews to clickthrough, among others. The system stitches exhaustive personas and their behavioral shifts, how they are interacting with your offerings, and how this impacts the bottom line. The system can handle large amounts of data and saves users from mining such data to understand what customers are predict trends and capitalize on future demand by finding anomalies and patterns in sales data. The system helps users in knowing which products appear most often across social media (comments, posts, videos, etc.) to stay on top of what's trending. Sales opportunities can be accelerated as the system can predict when customers will interact with brands and turn consumer behavior into sales opportunities and margin improvements. The system helps to optimize customer engagement and maps each customer to the products they actually want to buy and minimize markdowns by engaging them at the times they're most likely to purchase. The system increases revenue through proper inventory allocation and reduces carry-over across product catalog by capitalizing on niche buying and merchandising opportunities. The system improves decision making and identifies demand drivers and improves product development by unifying transaction data with external information about market trends. Bringing together applied machine learning, data science, social science, and managerial science, the system automatically recommends options to reduce the effort required to make higher-quality decisions for users.

### BRIEF DESCRIPTION

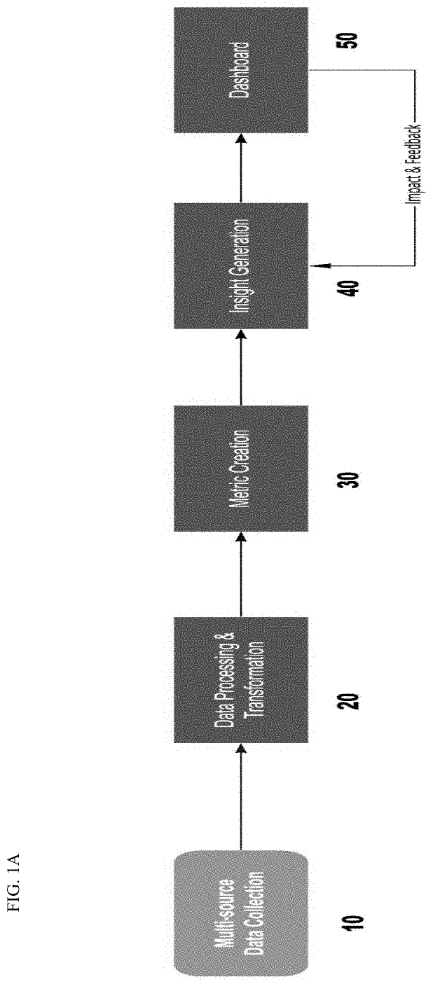

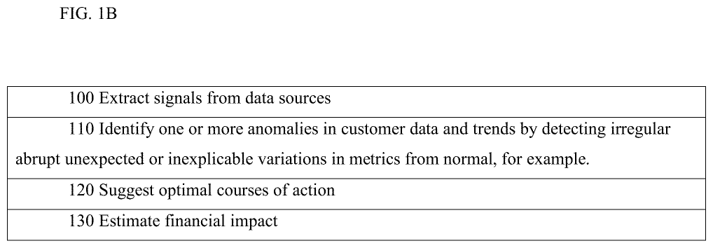

FIGS. 1A-1B show a high-level view of an exemplary system that provides automated business intelligence from business data to improve operations of the business.

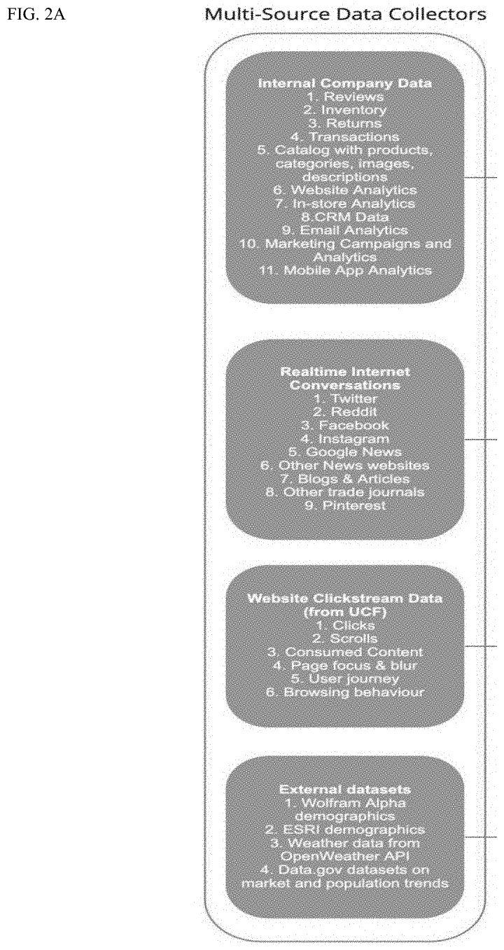

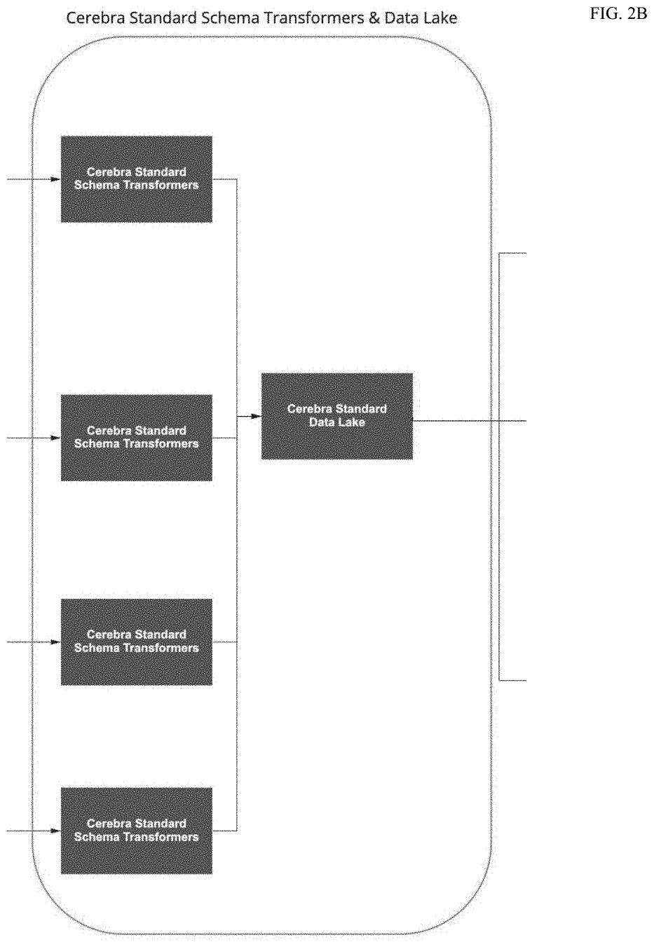

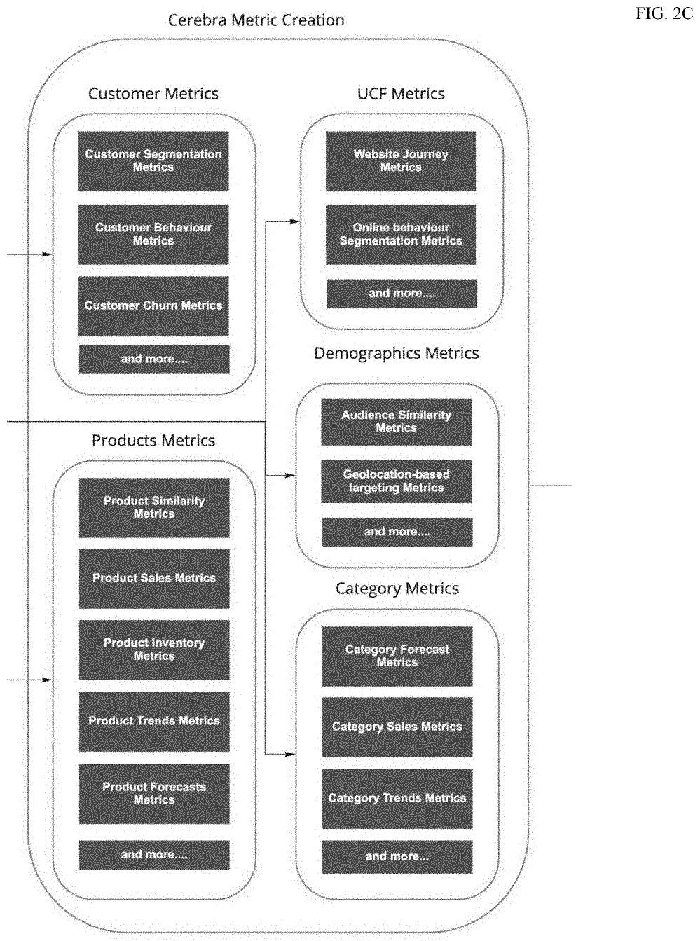

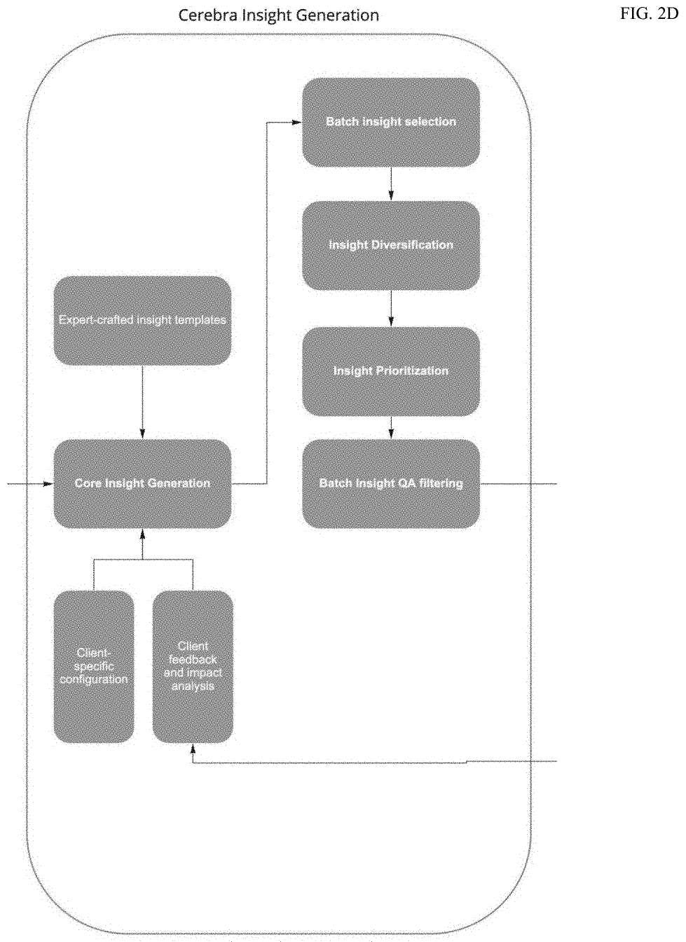

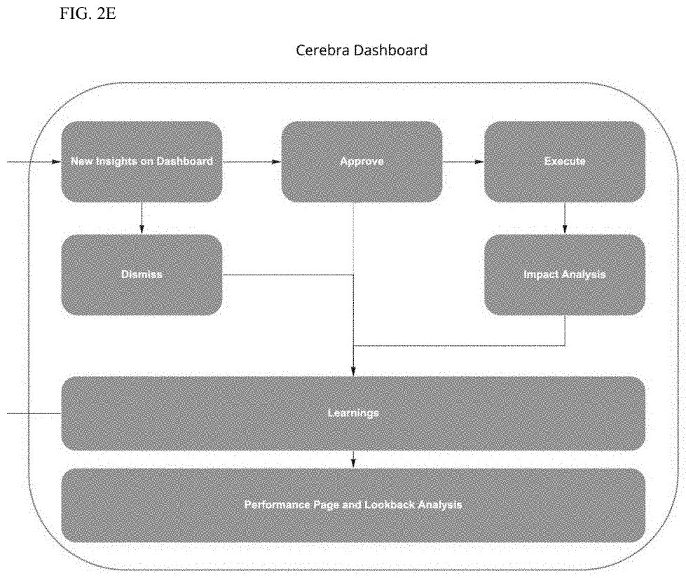

FIGS. 2A-2E show in more details the system of FIG. 1A.

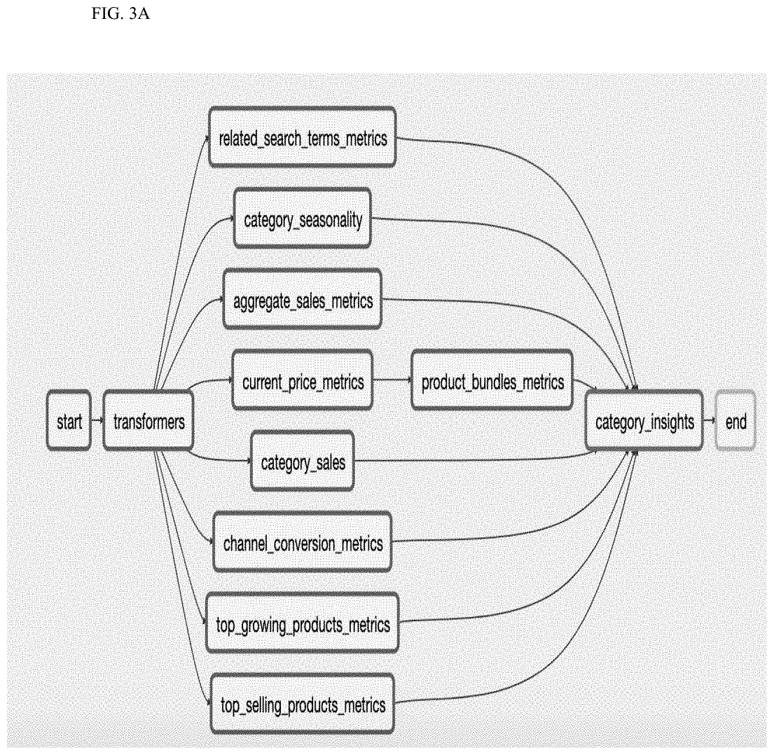

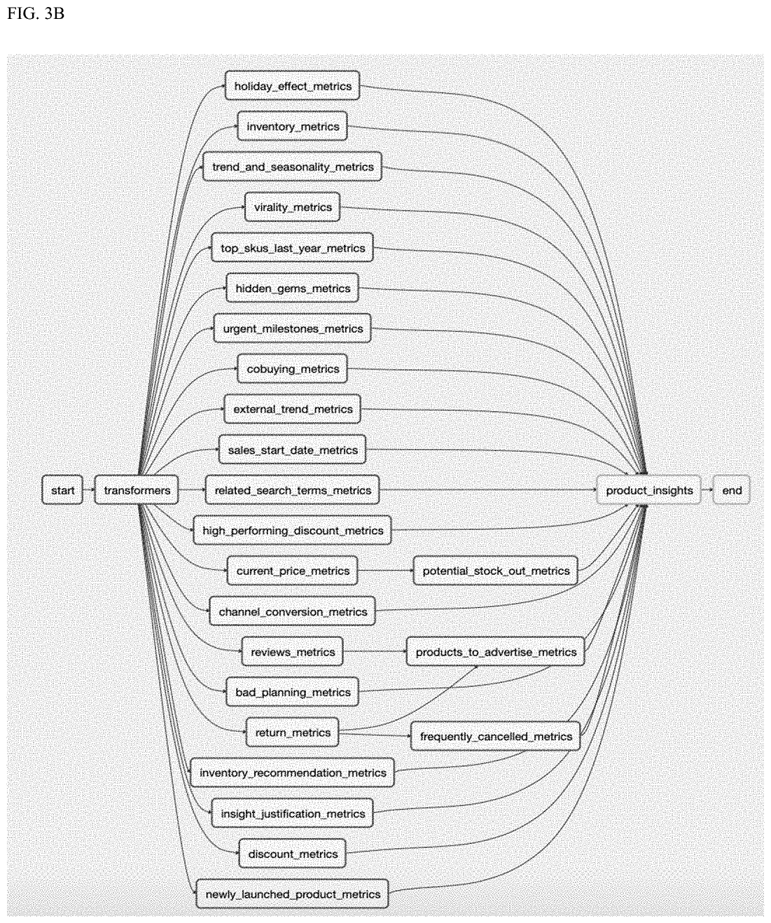

FIGS. 3A-3B show examples of how transformers map into metrics which are then used to generate insights.

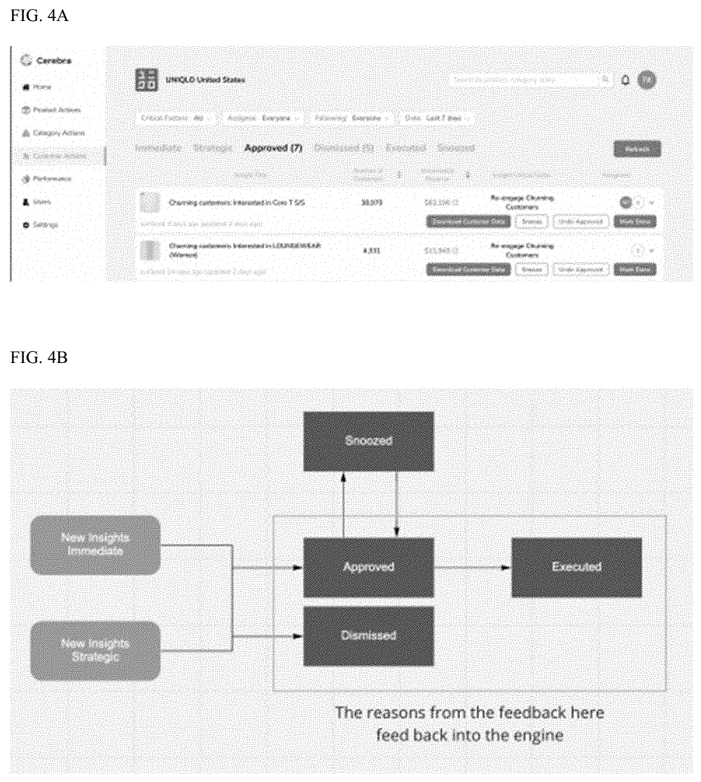

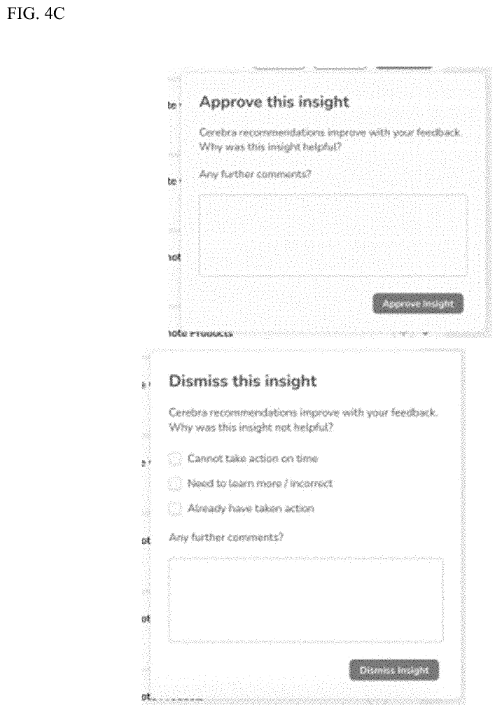

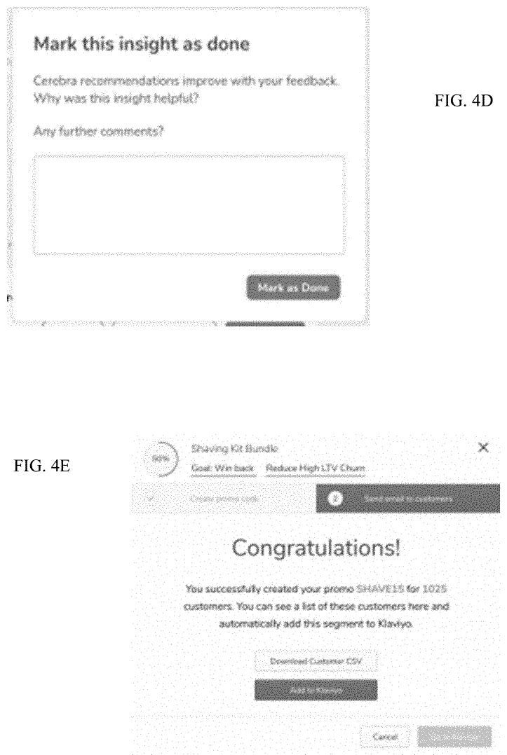

FIGS. 4A-4E show exemplary insight action flows.

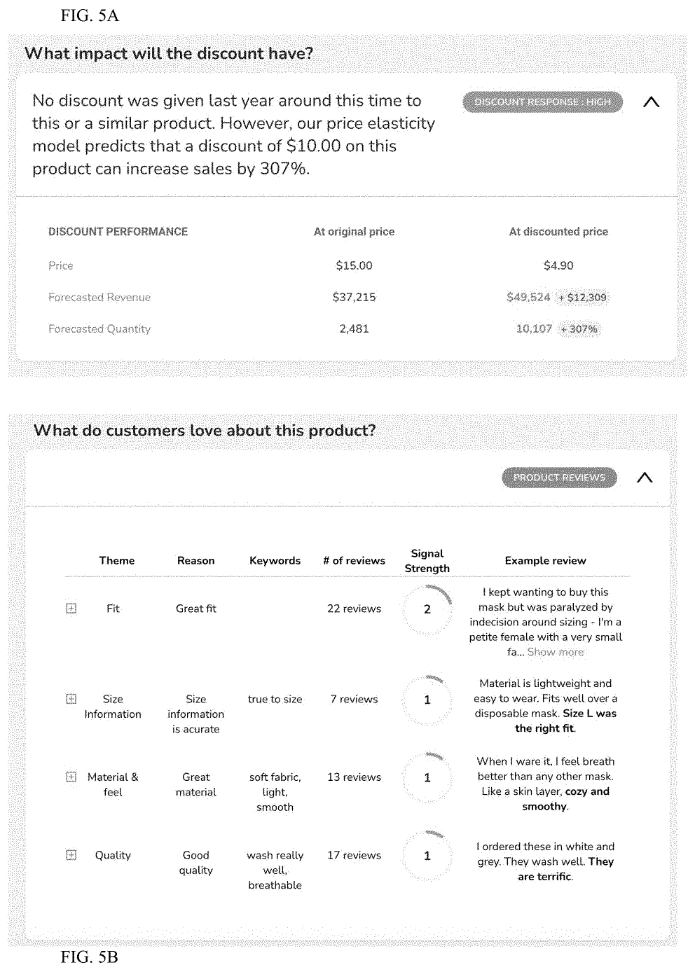

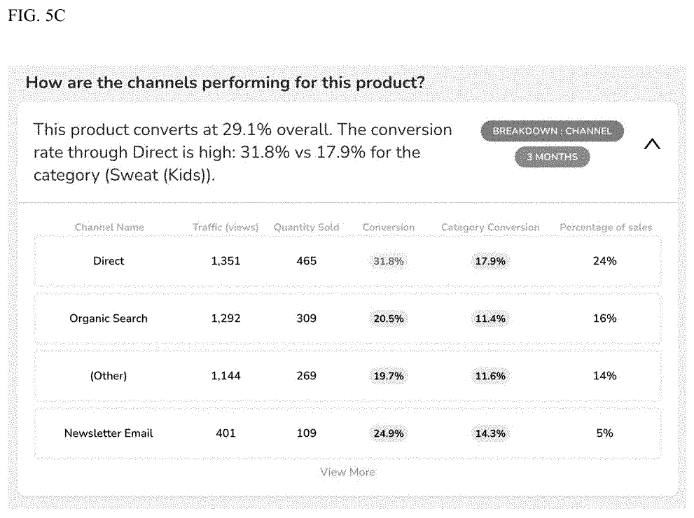

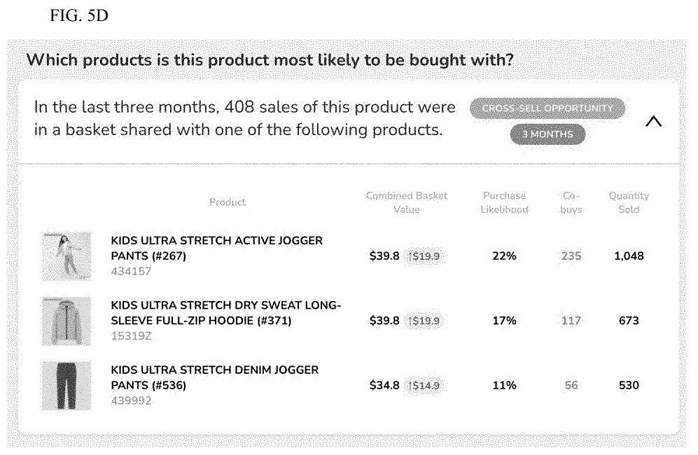

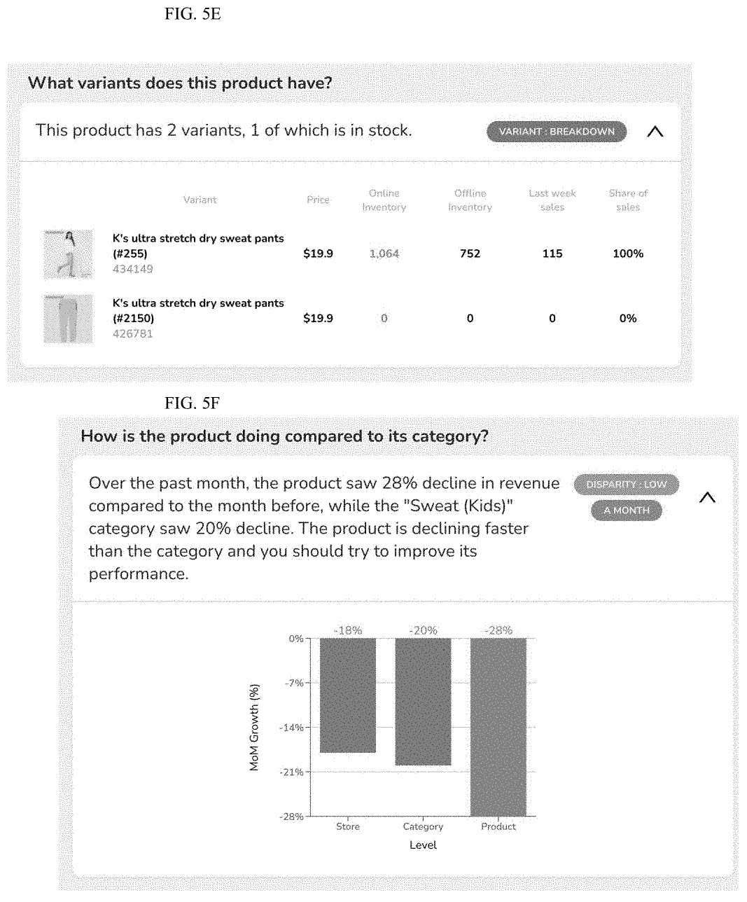

FIGS. 5A-5F show exemplary section cards.

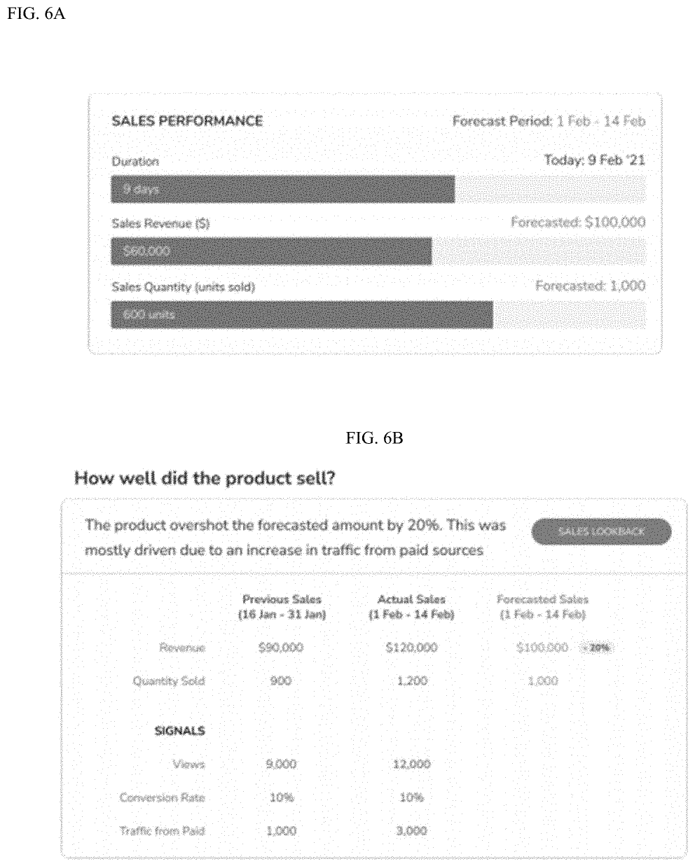

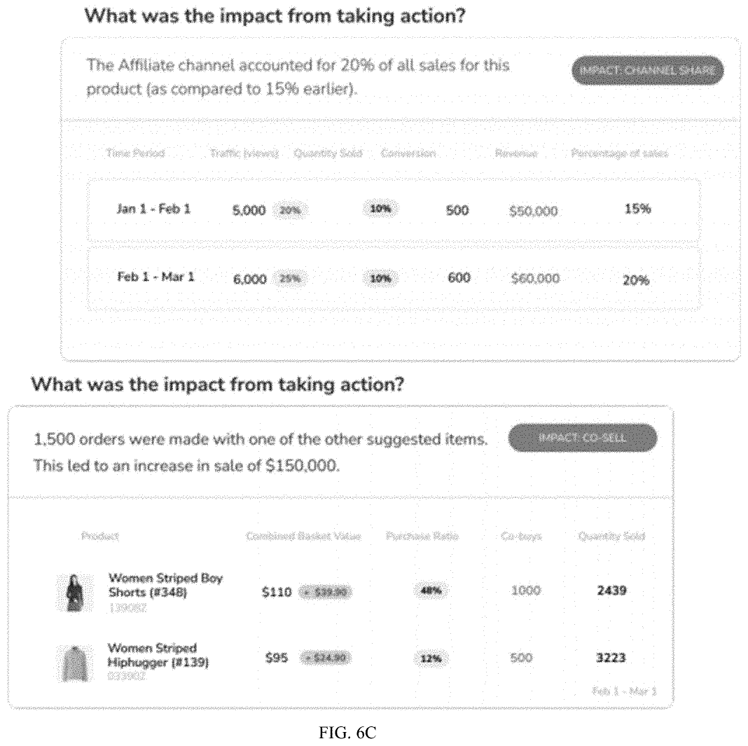

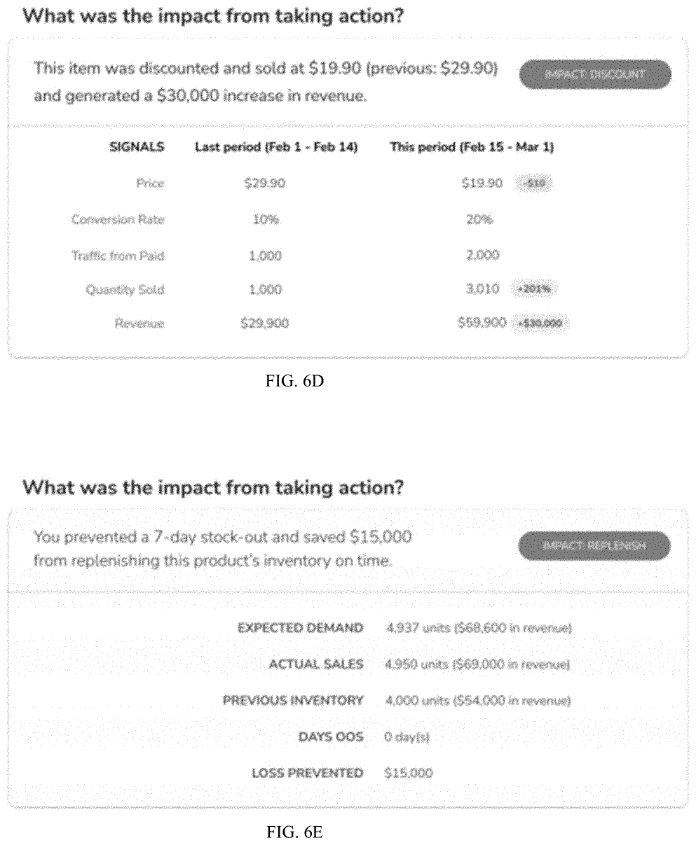

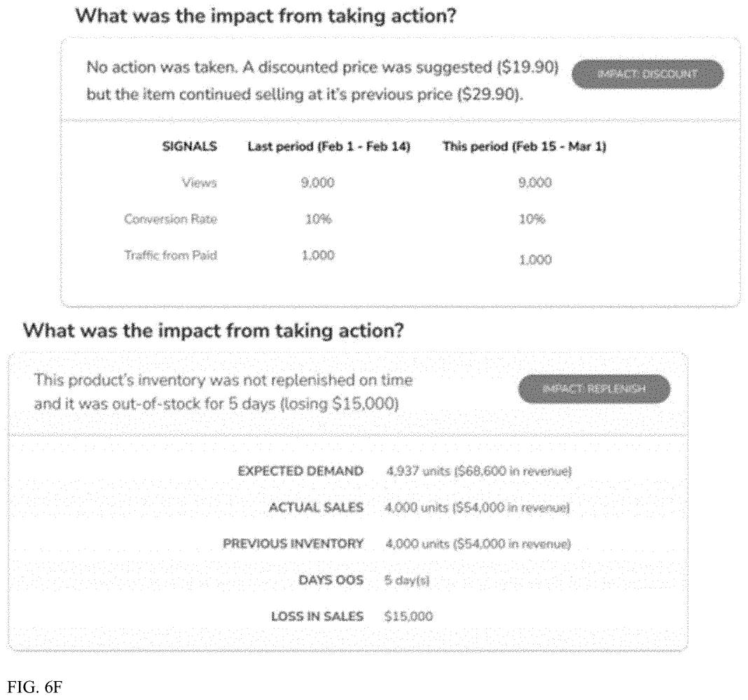

FIGS. 6A-6F show exemplary insights and look-back analysis offered by the system.

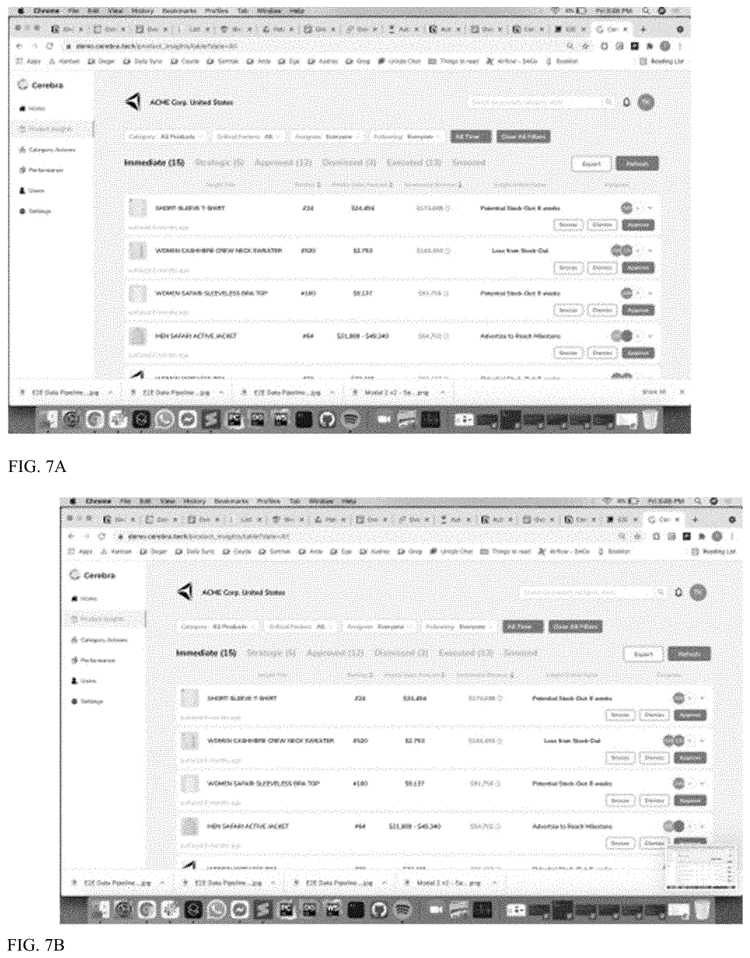

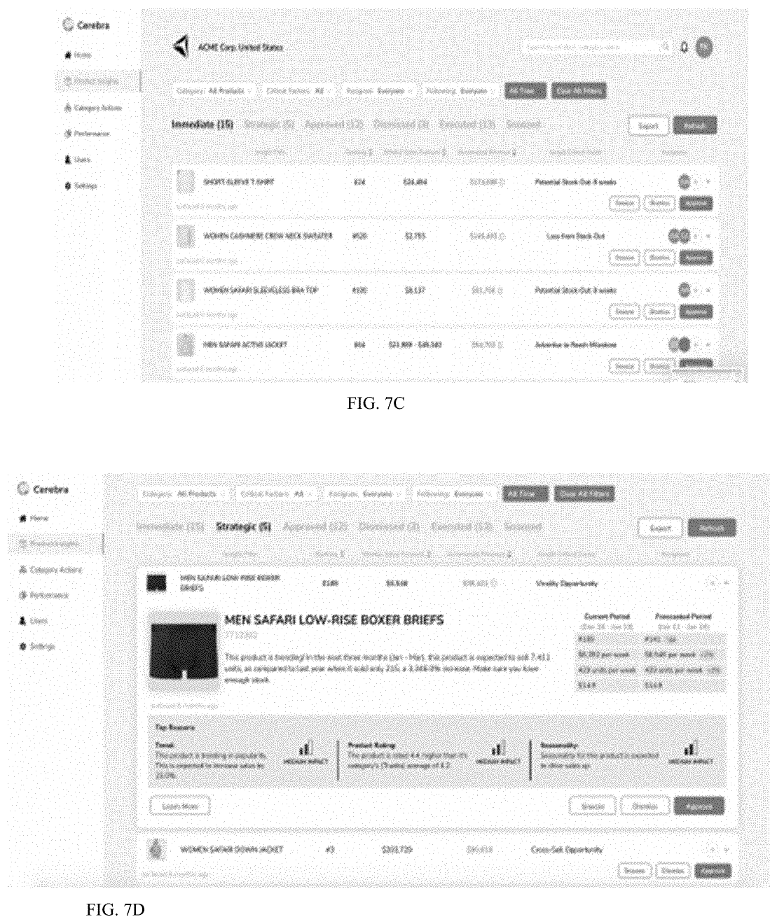

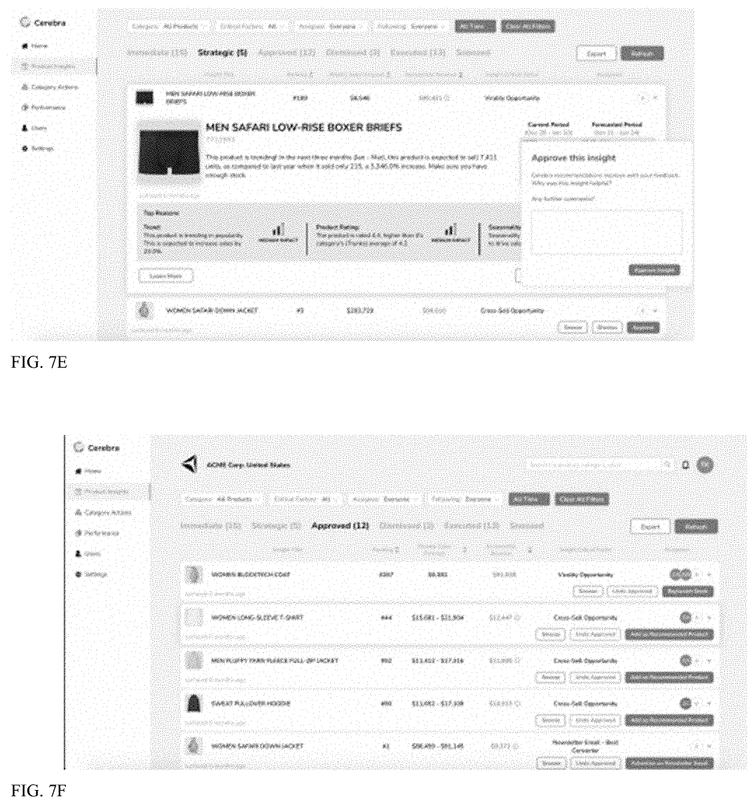

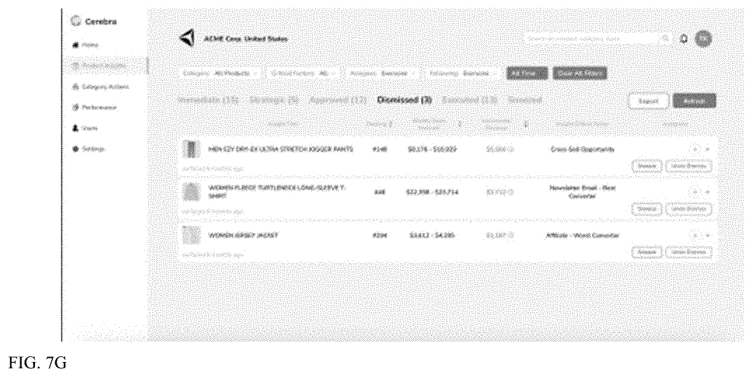

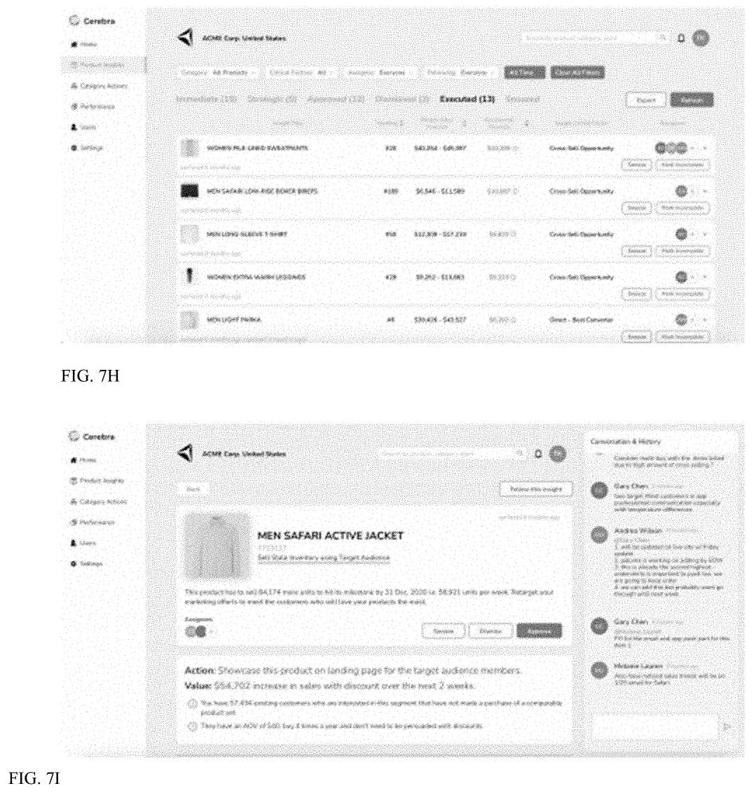

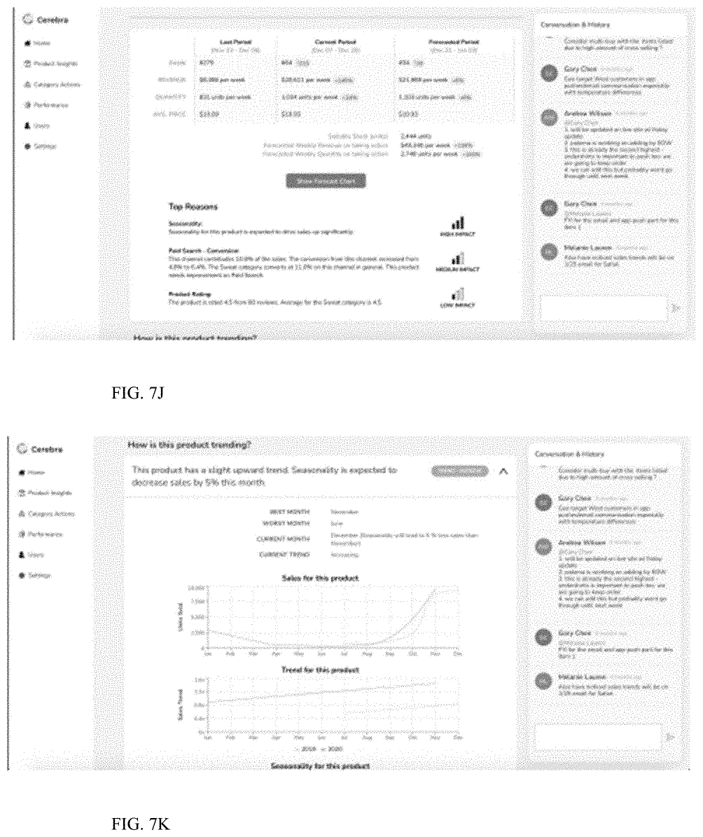

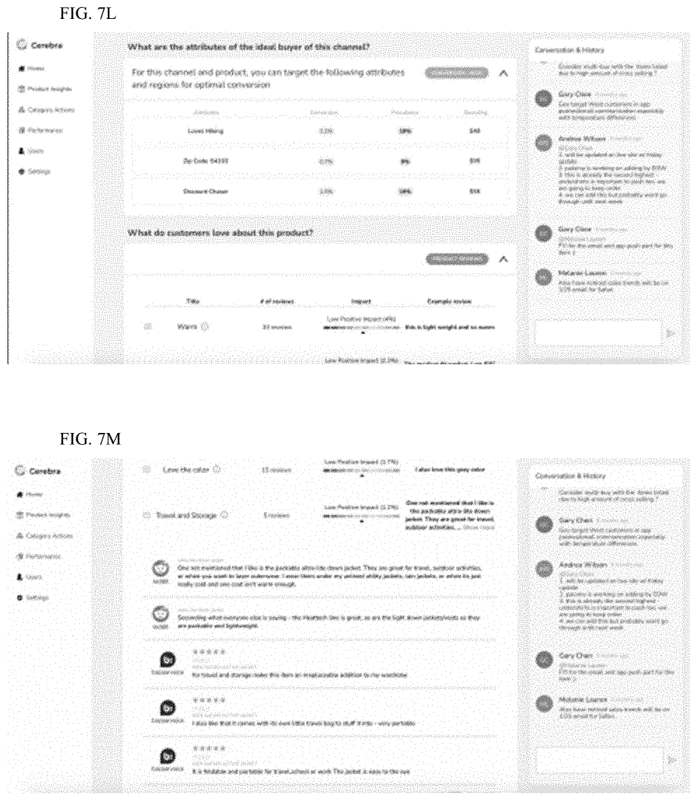

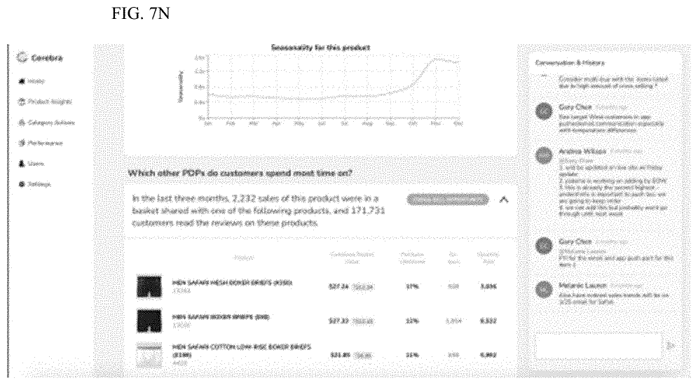

FIGS. 7A-7N show exemplary insight user interface (UI) screens.

### DETAILED DESCRIPTION

A detailed description of preferred embodiments of the present invention will be given below with reference to the accompanying drawings. In the following description of the present invention, when it is determined that a detailed description of a related well-known function or element may make the gist of the present invention unnecessarily vague, the detailed description will be omitted.

FIG. 1A shows a high-level view of an exemplary system that provides automated business intelligence from business data to improve operations of the business. The system extracts signals from any unstructured data source.

FIG. 1B shows an exemplary process to provide recommendations to users based on machine learning. The process includes:
100 Extract signals from data sources
110 Identify one or more anomalies in customer data and trends
120 Suggest optimal courses of action
130 Estimate financial impact

FIGS. 2A-2E show in more details the system of FIG. 1's flow showing Data Sources→Internal Schema→Metrics→Insights. The system identifies anomalies in customer data and global trends for retail companies that present opportunities and crises to avoid and suggests optimal courses of action and estimated financial impact. The system also alerts individuals with opportunities and predicts customers' needs. The system of FIG. 1 extracts signals from any data source, structured or not, to alert the user of opportunities and anticipate customers' needs. The system determines the trends, what products are hits, the opportunities to pursue, and when to reach out to customers.

As shown in FIGS. 1 and 2A, this is done by first collecting data from a multi-source data collection module 10. The data sources used by the system could include relational data sources, cubes, data warehouses, electronic health records (EHRs), revenue projections, sales projections, and more. Further, while the examples discussed herein relate to retailers, the system operates across all industries.

The multi-source data collection module 10 collects data from a variety of data sources. For example, the present system and method collect data from e commerce websites retail brick and mortar stores and social media including review sites. Such systems may include any number of analysis engines that enable management or other users to generate one or more analyses. The results of these analyses can be stored in one or more databases as well as used to facilitate decision making and where the system can predict customer behavior. This includes what customers will do in the future based on past actions. The system can predict customer behavior based on the multiple sources of information including unstructured text, video images, maps, weather, time of day, purchase history, competitor activity, social network activities, trends, forums, blogs, specific categories of product purchases, warranty claims, responses to advertisements, interactions with manufacturers, credit card transactions, voice calls, GPS/geographic location, market research, sensor information, email news, and trends. These predictions are made across all industries not just retail which enables greater depth of insight into customer's needs and wants. As these needs and wants can change quickly, the data is continuously updated to support real-time understanding of customer behavioral changes over time.

As the amount of unstructured data can be large, the conversion of these sources into structured data can be a daunting task. As shown in FIG. 2B, a data collection and transformation module 20 derives the data model for a company.

In one embodiment, a schema defines the data structures for storing data internally. All the structured, unstructured (text, image, among others), and tabular data is saved in this format. After ingesting raw data both from the clients and from external sources, transformers convert them into the Schema. All further metrics and entities are created from them. Once standardized data enables the system to process data regardless of where data was ingested from and only focused on what the data contains. This can be standardized across every company or retailer. The system can scale the data for a mom & pop shop all the way to large retailers. The system also ensures that code can run for different users. In one implementation for retailers, the system can

Analyze internal systems used by retailers to see what data they store

Analyze use cases from data science teams to see what data is needed

The pipeline comprises a series of tasks, which has some inputs and some outputs. The inputs can be marked as required or optional. In case a required input is missing, then the task isn't run (no review analysis). Where an optional input is missing, the task is run without the missing data. For example, if the product has good reviews to explain why it is trending, there is no need for reviews using the sales trend as well.

Finally, marking fields as optional makes the pipeline self-sufficient. With a large number of data sources, such options enable future data sources to be added iteratively over time. As the pipeline checks for requirements at every step, failed cases can still work whenever data or reviews are added—no manual intervention needs to be done.

The schema module addresses the difficulty in industrializing the work of data scientists with independent teams of data scientists for each client. The instant standard schema may represent all the data that is necessary and that will ever be needed.

In one exemplary embodiment, the data collection and transformation module 20 performs entity creation and transformed data creation as illustrated in the following exemplary operations:

Create Entities:
During customer data ingestion, the system creates the following entities first:
   Variants—this is the root level at which clients want to see information (eg SKUs, or atomic products)
   Products—this is a collection of variants, eg, A V-neck shirt with variants of all different colors
   Product Category—this is a category such as Shirts which contains all products
   Store—Some products are only sold in certain stores
   Customer—every customer with a unique ID
   Order—every order with a unique Internal Schema

Create a Base Transformed Data:
This is a structured format of all the data that the system can ingest and structure. This contains any and all data the system use. This is next used by the metric creation process.
The list of the atomic units the system defines:
Transaction Lines: This is a single line item from an invoice describing the sale of some units of an item, part of an order, to a customer, on a specific date, for a specific price
Channel Performance: Which users came from which sources, and calculates the traffic, revenue, and conversation rate.
Merchandise: This describes all the products, their names, prices, their variants and categories and (the hierarchy).
Catalog: This contains further information about every variant: it's color, size, gender, description, material, etc which is used to create an ontology of their product line
Inventory: Up to date inventory levels for each variant across all their warehouses
Returns: Customers who use return management systems can also share reasons for returned/cancelled ordered and other customer notes
Reviews: A standard review format that can integrate reviews from every single source available
Milestones: Sales goals that the retailer or Cerebra has set
Customers: All information about their customers including location, channel, other behaviours, etc
Raw UCF events: These are clickstream events that track every single user action on the e-commerce store.
Demographic Information: Demographic information on a zip code, city, county, and country level for understanding users
Social media: A consistent schema to store activity from Reddit, Twitter, among others
Facebook, Instagram, etc—it stores information about the user, their post, metadata for links, and images attached if any.
News: A consistent schema to store all news stories from Google News and all independent news sources
Email Performance: Stores every email sent to every customer and tracks the activity—did they customer open, click, buy?
Internet Catalog: This contains the catalog of 1000s of online stores and marketplaces including the website link, product name, images, description, price, for example.

In FIG. 1 and in more detail in FIG. 2C, a metric creation module 30 provides trend identification and prediction using neural networks as part of a user s marketing strategy may be useful to generate revenue for the enterprise however systems for doing so have historically been manual and slow to counter these limitations. The system provides an automated approach that sifts through millions of customer related records to identify patterns in both macro trends and behavioral shifts to predict behavior and to forecast when it will occur.

Next the anomaly detection is detailed. The system identifies shifts in business through analyzing large amounts of data in order to detect anomalies, which are identified by observing irregular abrupt unexpected or inexplicable variations in metrics from normal. In other implementations, identifying anomalies involves the identification of unusual values in time series data time sequence data. In yet other implementations, statistical forecasting statistical forecasting can be used for making inferences about future events on the basis of past events. Time series forecasting differs from most other forecasting techniques in that time series techniques focus primarily on historical information rather than external sources of information such as trends or predictions of related companies or markets, but it is less affected by unforeseen events as only historical information is used.

An exemplary processing of data for a retailer is detailed as: Data Sources→Internal Schema→Metrics→Insights

Entities form the core backbone of the platform. An entity can be a store, a product, a sku, a category, a customer, customer segment, or anything which is a tangible unit which can be taken action on, and has metrics. Each insight is generated for an entity. Each metric is an attribute generated for an entity.

As the system generates any insight or any metric, they are all connected to an entity. Entities can also define hierarchy. With an example of products, the system may have:
All Products→Category→Product→Variant
All Products: represents the store level aggregate of metrics Category: Can be for example Linens, Blazers, or Fall Collection Product: Can be for example “V-neck short-sleeve T-shirt”
Variant: Can be “V-neck short-sleeve T-shirt, M, Black”
Insights about a product can mention their category or give a breakdown about their different variants. Similarly, insight about a category can talk about the top products.
Some stores have more complicated hierarchies, in which case the system can change how the system use the definition of these words but from the point of the framework, it has the same meaning.

Once anomalies are detected, insights can be generated to aid users in correcting course. FIG. 2D includes an insight generation module 40 may include information from any source that can be analyzed to provide insights. In one embodiment, the data is structured and or unstructured. For example, a customer review or feedback may be obtained from the company's own site or can come from another product review website such as yelp amazon. Additionally, other sources of structured data such as transaction records or call center data may be obtained. Additionally, in some embodiments, machine learning methods may be used to detect anomalies in the data to generate customer insights. Information for business intelligence source is available through various methods including internal reports and externally via services. internal web services reporting can come from business intelligence (BI) vendors, ERP systems, CRM systems, inventory management systems, digital marketing tools and others. Access can be provided through standard protocols to open data stores, open databases or proprietary data stores.

FIG. 2E shows a dashboard module 50 with a mix of reports visualizations and messaging to make it easy for users to track the health of their business in real time. The dashboard module 50 also guides users through their decision-making process with reporting that makes it easy to see at a glance what is going on and where they should focus their attention. The dashboard combines data from various sources such as ecommerce data social media news feeds, clickstream analysis to identify new patterns, and anomalies, financial analysis to provide context for understanding where costs are going and visualization to guide users decision making. The system social connector automatically parses unstructured text to extract rich information about people, places, and things within a company. The system automates this traditionally manual and laborious process so people can connect with their businesses in entirely new ways.

In one embodiment, a migration utility provides centralized automated migration from disparate systems to a single view of the customer across a variety of business functions and sales channels. Users can transform massive amounts of information to gain comprehensive, real-time views of the customer that are needed to run successful business today. The user interface supports data analysis by simplifying its extraction representation manipulation storage retrieval transmission and visualization.

An exemplary flow showing operations from Data Sources→Internal Schema→Metrics→Insights is detailed next.

1. Transformers: Data Sources→Internal Schema

With the growing use of SaaS platforms, every company uses a slightly different stack, leading to a diverse number of data sources where eventually, all these need to be processed by the data science pipeline to generate insights. For example, the data can be from third party email platforms such as MovableInk, Klaviyo, SendGrid, MailChimp, or from third party Store Management Platforms such as WooCommerce, BigCommerce, Shopify, SQL database, among others. The underlying data they contain is the same. An invoice line item will always have the same set of core fields irrespective of where the system get the data from. The source of the data and its initial format should be abstracted away from the data scientists and the data pipeline. The system can ingest a number of data sources and they can be categorized into different information types: eg. inventory, transaction line, page views/conversion, item catalog information, etc.

The system then applies a defined Internal Schema—a common framework that can work for a wide variety of clients. The transformer functions convert each data source (or combination of data sources) into one (or multiple) internal schema formats. The transformed internal schema files are all saved as Pandas parquet files which are timestamped by their date. These are devised to be modular. For example, transaction lines and returns can be represented in the same DataFrame, but the system can separate them to ensure that the system can easily check if a client has specific returns information or not and proceed accordingly.

The modularity also means that the system can add new data sources without breaking any existing clients. New clients need only the bare minimum (transaction lines, product catalog) to start working with the system. The system can define dependencies and break every information piece into its atomic units.

For third party platform integrations with Shopify, Google Analytics, the system needs to write the transformer once per platform. For custom enterprise integrations, a custom transformer is used for each integration. For example, the transformer can read customer's csv dumps about their item catalog. The system runs jobs that pull the data from all these sources and store the raw data in j son/csv/Pandas parquet files. These jobs are arranged in a directed acyclic graph because they can depend on each other. For example, the system would need to have the item catalog before the system can pull the reviews.

2. Metric Generation: Internal Schema→Metrics

This is the step for all statistical analyses, machine learning, and deep learning models that work with all the data that is present. Various examples are shown in FIGS. 3A-3B.

The benefit of the internal schema is that:
The data scientists don't have to worry about column names
They are invariant to the source of data
They can easily check if a particular information unit exists or not (e.g., reviews, social media signals)
They can write code once and deploy to all customers.

This enables the system to collate all computationally intensive tasks together. Furthermore:
These tasks are arranged in a directed acyclic graph.
This allows future metrics to use computations from previous metrics.
Non-dependent tasks can be parallelized across machines.
Each metric can be individually tested with unit tests to make sure that the whole pipelines functions as expected.

Each metric file has some required and some optional internal schema files it needs. It then generates a set of metrics relevant to a particular “metric-set”. For example, a “Channel Conversion” metric file uses the transaction and conversion internal schema files to generate a DataFrame where for each product, the system can see the views, orders, quantity sold, revenue, and fraction of sales coming in through each channel. The metrics also include deep-learning models for forecasting and the NLP stack. The goal is to do a majority of the computation at this step so that once the metrics are generated once, doing any processing on top of them is computationally trivial. In one embodiment, the metrics are all saved as Pandas parquet files which are timestamped by their created at date.

3. Insight Generation: Metrics→Insights

The system processes all structured and unstructured data sources together to create actionable insights. The insight is the final output of the data pipeline. An insight consists of three parts:

what is happening

what needs to be done

what will happen if recommended action is taken

Insights are created for entities. On the dashboard, there are different pages for different kinds of entities. Insights can be for Products, Product Categories, Customer Segments, and Stores, among others. This can be seen in the screenshot below on the left sidebar of FIG. 4A. The overall flow for the Insight Action Flow is described in FIG. 4B. In FIG. 4B, there are three operations:

Step 1 New Insights

These are generated every week, for example. (The frequency can be tailored to client needs). Insights can fall into two categories:
Immediate: The actions from these insights can be executed immediately (e.g. Sending an email, giving a discount, marketing on a channel).
Strategic: The actions from these insights are related to longer-term planning that cannot be immediately done (e.g. ordering more inventory for next season, preparing for viral trends in a few months, new product launch ideas).

Step 2 Triaging Insights
Users go through these insights on the dashboard and can approve or dismiss each insight and provide a reason. This reason is used by the insight creators to update how the insights are generated, as shown in FIG. 4C.

Step 3 Executing Insights

Insight that are approved contain actions that need to be done. There are two ways an action can be completed:

The user manually opens an approved insight and follows the instructions manually. Once this is complete, they mark the insight as done. Eg “Order more inventory for this item”. They add any comments they have about the insight. An exemplary UI is shown in FIG. 4D.

The user opens an approved insight and has a one-click integration to take action on the insight, as shown in FIG. 4E. For example, the user can command “Quick send an email to these 10,000 customers”. This is done through integrations with a number of platforms for example Email, Shopify, Marketing tools, among others.

Step 3a: Snoozing Insights
At times for approved insights, actions can't be taken right now. In that case, users can snooze the insight to be shown again at a later date for the action to be taken.

Each of these three points are backed by “section cards” that showcase facts which led to the conclusion. Each section card is a fact followed by contextual information.

The section card processing is separated from the metric creation process because insight scripts are simpler parts of the stack that lean more on narrative and explicit logic—the second card is computationally light. They use the thresholds and numbers already calculated from the metrics. Each insight script develops a type of insight (eg. discount to reach milestone) for all products that fit that bucket. This runs in a few minutes and allows the insight creators to iterate on insights faster and avoid running computationally-intensive metrics again while creating a new insight or generating insights for clients. The approach also abstracts the computational logic from the insight creators and they only need to focus on creating the insight logic. For example: they will get a field call “Churn Probability” which is a probability for a particular customer churning from this brand. This is computed with deep learning models but the insight creator can take this at face value.

Each insight file has required and optional metrics it can use. For example, while giving a discount insight, it is essential to have the discount metric, but it can add more explanation to also show the conversion statistics (if this isn't present, the section related to conversations will not be populated).

In addition to creating the sections (these are separately placed to reuse sections), the insight files have logic to write down the narrative for the insight and action to be taken, in addition to calculating the incremental revenue that would be generated if the action is taken as planned.

The output from all insight files go to the master insight controller

Final Step: At the End of the Pipeline

Once all the insight scripts contribute their insights, each insight type is sorted by their incremental revenue. The master insight controller picks the insights to show in a round robin fashion, picks N insights and pushes the payload to the database which the Cerebra Dashboard uses to track insights shown to clients.

In another implementation, the system not only converts text to structured form but also extracts signals and generates useful insights in its analysis. For example, the system identifies anomalies and patterns in customer data and global trends for retail companies that present opportunities and crises to avoid and suggests optimal courses of action and estimated financial impact. The system enables users to understand what customers are thinking by extracting insights from any open-ended text including chat logs product reviews transcripts and more.

The system helps users perform data driven merchandising for example to answer which product attributes are most likely to surge and underperform in the next season and why, for example. The system can identify marketing ROI and answer questions such as what are the products and customer segments that would benefit the most from operational changes and what are the right assortments to highlight. The system extracts signals from unstructured data source and identifies anomalies in customer data and global trends for companies such as retail companies that present opportunities and suggests optimal courses of action and estimated financial impact, among others.

FIGS. 5A-5F show exemplary section cards. A section card is a fact shown in an insight on the Dashboard that is calculated from a combination of data sources after transforming them to metrics to generate narratives for insights. The card is relevant to the conclusion of the insight and has contextual information in supporting the card's claim. The card consists of a claim, which is a brief of the fact being desribed. This provides further information on

what is the event that triggered this insight

what is the action that should be taken and why

how to calculate about the potential business impact from taking this action

a tag showing what category this card falls into, and

contextual information or data that was used to make the claim

FIGS. 6A-6E show exemplary insights and look-back analysis offered by the system. For example, a Sales Forecast Lookback after Forecast period can answer questions such as: Why did the deviation happen? What were the underlying factors that changed? This is made visible on all cards at the end of their forecast period. The reasons can be one of many: Increase/decrease in marketing, Increase/decrease in views or conversion from a particular channel Increase/decrease in price, among others. In FIG. 6B, the sales were expected to increase to $100k but instead hit $120k because there was more traffic from paid channels (i.e. increased marketing spend).

An Executed Action Lookback can be provided. These give detailed information into how the specific action that was taken by the customers impacted their sales. While developing any new action set for a client, the lookback logic is created hand-in-hand. Every action comes with a timeframe associated with it. For example, “Market this product on the Affiliate channel for 14 days. This will generate $10,000 in additional revenue”.

The system analyzes the sales to see how it had performed to previous expectations and if the action had the intended impact. In FIG. 6C, the action was to cross-sell the given item with these other items. In FIG. 6D, the insight recommends giving a discount to increase sales. FIG. 6E prevents a stockout by showing an early alert to replenish stock for an item. FIG. 6F shows two catch times when insight is marked as “Executed” yet no action was taken.

One embodiment performs content analysis (K-Means) to ensure that the predicates cover all the labels covered in the customer reviews. A text processing pipeline performs the following:
pre-processing: recovery of the title and comment text to reduce the size of the texts to a ‘sentence’ size in order to provide it to the ZSL for labeling
ZSL labeling: labeling of the sentences based on the predicates determined in the ‘Review Predicates—Return Reasons’ table.
post-processing: computing the output of the ZSL to aggregate the top 3 zsl scores of each sentence and then aggregating all the results of all the sentences into a distribution labels (in percentages).

The exemplary results below can allow a search by label selection . . . for example if a retailer wants to have all the reviews for which the color is great but after a wash, the item has shrunk or has been deformed.

Title: He's Worn it Daily for Two Years!
Results: [(‘a good quality product’, 0.9828834533691406), (‘a well made item’, 0.9712224006652832), (‘the size fitting perfectly’, 0.9139087796211243)]
Content: My husband LOVES this vest. He wears it all the time. I've replaced it once, and have purchased two spares for when these wear out, and in case Uniqlo stops making them. It's a perfect weightless layer of warmth, and a wonderful clean style. It's almost a jerkin. Our neighbor saw it and bought several, as well, and now they're twins.
   My husband LOVES this vest: [(‘a good fitting oversized item’, 0.9955286979675293), (‘a well made item’, 0.9951058626174927), (‘a good quality product’, 0.9839603304862976)]
   He wears it all the time: [(‘an oversized item’, 0.9708534479141235), (‘a good fitting oversized item’, 0.9575284123420715), (‘a well made item’, 0.9345663189888)]
   I've replaced it once, and have purchased two spares for when these wear out, and in case Uniqlo stops making them: [(‘a damaged package or product’, 0.960246741771698), (‘a good quality product’, 0.8838368654251099), (‘a defective product’, 0.8713430166244507)]
   It's a perfect weightless layer of warmth, and a wonderful clean style: [(‘a good quality product’, 0.9972696304321289), (‘a well made item’, 0.9963220357894897), (‘a good design’, 0.9820324182510376)]
   It's almost a jerkin: [(‘an unexpected look’, 0.9993101954460144), (‘an oversized item’, 0.9993072748184204), (‘a design imperfection’, 0.9971190690994263)]
   Our neighbor saw it and bought several, as well, and now they're twins: [(‘a well made item’, 0.9422255754470825), (‘a good quality product’, 0.9347414970397949), (‘a change of mind’, 0.8047310709953308)]
===Summary:===
He's worn it daily for two years!
   Scores=>Quality_POS: 34.27%, Design_POS: 33.86%, Size_POS: 31.87%
My husband LOVES this vest. He wears it all the time. I've replaced it once, and have purchased two spares for when these wear out, and in case Uniqlo stops making them. It's a perfect weightless layer of warmth, and a wonderful clean style. It's almost a jerkin. Our neighbor saw it and bought several, as well, and now they're twins.
   Scores=>Design_POS: 22.48%, Quality_POS: 22.08%, Size_NEG: 11.45%, Size_POS: 11.35%, Design_NEG: 10.86%, Description_Matching_NEG: 5.81%, Fit_POS: 5.71%, Damaged_NEG: 5.58%, No_Longer_Needed_NEG: 4.68%
==========

Title: Almost Perfect Jacket
Results: [(‘a well made item’, 0.998344361782074), (‘a good quality product’, 0.9981902241706848), (‘a good fitting oversized item’, 0.998034656047821)]
Content: I bought this as a 5′4 woman, and this jacket is almost perfect! My only complaint is the arms are too big for me, but I think that's to be expected. 100% in terms of style though.
   I bought this as a 5′4 woman, and this jacket is almost perfect: [(‘a good quality product’, 0.9981216788291931), (‘a well made item’, 0.9970242977142334), (‘a good fitting oversized item’, 0.9961802363395691)]
   My only complaint is the arms are too big for me, but I think that's to be expected: [(‘an oversized item’, 0.9880087971687317), (‘a problem with the size’, 0.9734795093536377), (‘a problem with the fit’, 0.9585652947425842)]
   100% in terms of style though: [(‘a good design’, 0.9291527271270752), (‘a well made item’, 0.9246700406074524), (‘matching the description perfectly’, 0.8770319223403931)]
===Summary:===
Almost perfect jacket
   Scores=>Design_POS: 33.34%, Quality_POS: 33.33%, Size_POS: 33.33%
I bought this as a 5′4 woman, and this jacket is almost perfect! My only complaint is the arms are too big for me, but I think that's to be expected. 100% in terms of style though.
   Scores=>Size_NEG: 22.7%, Design_POS: 22.24%, Quality_POS: 11.55%, Size_POS: 11.53%, Fit_NEG: 11.09%, Fit_POS: 10.75%, Description_Matching_POS: 10.15%
==========
Title: Great wardrobe staple
Results: [(‘a good quality product’, 0.9908140301704407), (‘a well made item’, 0.9851133227348328), (‘an item that runs big’, 0.9809804558753967)]
Content: This is a great blouse to have because it is so versatile. It can be worn for work or casual occasions. I have it in several colors, including black, pink, navy, and light blue. It is very comfortable to wear and easy to care for. It would be nice if there were other colors in this design for example red or dark purple.
   This is a great blouse to have because it is so versatile: [(‘a well made item’, 0.996089518070221), (‘a good quality product’, 0.9935836791992188), (‘a good fitting oversized item’, 0.8850324749946594)]
   It can be worn for work or casual occasions: [(‘a good quality product’, 0.9904789328575134), (‘a well made item’, 0.9806917905807495), (‘a good fitting oversized item’, 0.9551547169685364)]
   I have it in several colors, including black, pink, navy, and light blue: [(‘a good quality product’, 0.9290283918380737), (‘a well made item’, 0.8164324760437012), (‘a good shade or tone’, 0.8019659519195557)]
   It is very comfortable to wear and easy to care for: [(‘a good quality product’, 0.9979749321937561), (‘a well made item’, 0.9959721565246582), (‘a perfect fit’, 0.9643032550811768)]
   It would be nice if there were other colors in this design for example red or dark purple: [(‘a color issue’, 0.9653227925300598), (‘a problem with the style’, 0.8832076787948608), (‘a design imperfection’, 0.8639394044876099)]
===Summary:===
Great wardrobe staple
   Scores=>Quality_POS: 33.51%, Design_POS: 33.32%, Size_NEG: 33.18%
This is a great blouse to have because it is so versatile. It can be worn for work or casual occasions. I have it in several colors, including black, pink, navy, and light blue. It is very comfortable to wear and easy to care for. It would be nice if there were other colors in this design for example red or dark purple.
   Scores=>Quality_POS: 27.9%, Design_POS: 27.03%, Size_POS: 13.13%, Color_NEG: 6.89%, Fit_POS: 6.88%, Fit_NEG: 6.3%, Design_NEG: 6.16%, Color_POS: 5.72%
==========

One embodiment generates a UCF (Universal Customer Fingerprint) which tracks user behavior in detail. The UCF has 3 modules:

1. Detecting content consumption based on where the user spent time on.

2. Calculating a user's fingerprint based on their browsing behaviour so we can tie multiple sessions from the same device together (instead of using 3rd party cookies)

3. Determining a user vector based on their text consumption

In another embodiment, as the system pushes insights to users or clients, the system checks that:

The actions have a significant business impact

There are no missing data sources

There is no ‘bad data’ coming from data sources

There were no errors or drops anywhere in the data pipeline

These are challenges that come up with having fully automated and scalable systems that can adapt to any combination of data sources that are sent to it. To this end, after the insights are generated but before they are pushed to out clients dashboard, they are run through the automated QA process. The automated QA process checks for the following

Make sure all must-have sections are present and are not empty

Make sure the incremental revenue is higher than the minimum set by the client (eg. only show insights with $2,000 in revenue)

Make sure no blacklisted products are present (eg. those that have been discontinued, or those that are one time sales)

Make sure the forecasts are reasonable and there are no unexplainable trends P Check if the product link is valid

Check for any computational issues for example NaN and infinity values

Automated QA 1

Make sure all the variants in the product are included and their inventory values add up

Make sure there are no duplicate insights shown recently

Make sure there are no contradicting insights

Make sure there are no product duplicates

Make sure none of the core input data sources are empty

The automated QA test can be defined explicitly with a simple config file that is created for each client, which makes it easy for anyone to update the rules and thresholds for all the QA tests. In doing so, we maintain a single automated QA framework for our entire platform while at the same time allowing for client-level modifications.

In another embodiment detailed in the incorporated by reference applications, the system provides a method to automatically associate a product or a service with external content by:
characterizing the product from unstructured data sources including a product text or text from similar products;
generating a label for the product or service;
applying the label as a search engine;
extracting signals relating to the product or service; and
providing business intelligence for the product or service.

The text extraction includes selecting a predetermined number of text identified by TF-IDF (term frequency-inverse document frequency).

The text extraction includes applying an explainability of an attention model to see if the attention model provides one or more keywords or tokens to keep.

The text extraction includes obtaining a primary keyword from a search term and obtaining a secondary keyword from the primary keyword and labeling the product text by word-set-match or by zero-shot learning (ZSL).

The text extraction can also include:
aggregating product titles and descriptions;
identifying n-grams and stopwords from the product titles and descriptions;
extraction by POS of tags to keep predetermined tags; and
determining term frequencies for each product and creating a bag-of-word (BOW).

The method includes representing the product or service as a multimedia file; extracting meta data for the product or service corresponding to the multimedia file; and discovering keywords that connect the image to external signals coming from social media, news articles, or search.

The multimedia file comprises a picture or a video. The external content comprises one or more words in a search term. The method includes extracting signals from a social media site or from a search engine.

Another method can link a product or service to an external content by discovering one or more keywords associated with the product or service; and linking the product or service with the external content from social media. The text extraction can include selecting a predetermined number of text identified by TF-IDF (term frequency-inverse document frequency). The text extraction comprises applying an explainability of an attention model to see if the attention model provides one or more keywords or tokens to keep. The text extraction comprises obtaining a primary keyword from a search term and obtaining a secondary keyword from the primary keyword and labeling the product text by word-set-match or by zero-shot learning (ZSL).

In another embodiment detailed in the incorporated by reference applications, the system can incorporate data from a customer review of a product. This is done by extracting product categories and predicates from the customer review; extracting product features from the customer review; extracting an activity with the product features from the customer review; performing sentiment analysis using a learning machine on the customer review; determining a life scene from the customer review; and analyzing a customer opinion from the customer review.

In implementations, the system includes applying a language model to detect a language of the customer review. The system includes extracting the customer opinion from a review title or review content. The system includes extracting categories and predicates from a review title or review content. The system includes determining a polarity of the product category and electing the category. The system includes extracting product features from a review title or review content. The system includes extracting a user activity with the product from a review title or review content. The system includes performing sentiment analysis from a review title or review content. The system includes performing chunk extraction on a review title or review content. The system includes extracting a life scene from a review title or review content. The system can modify the preprocessed text by using coreference.

It is to be understood that the above description is intended to be illustrative, and not restrictive. For example, the above-described embodiments (and/or aspects thereof) may be used in combination with each other. Many other embodiments will be apparent to those of skill in the art upon reviewing the above description. The scope of the invention should, therefore, be determined with reference to the appended claims, along with the full scope of equivalents to which such claims are entitled. In the appended claims, the terms “including” and “in which” are used as the plain-English equivalents of the respective terms “comprising” and “wherein.” Also, in the following claims, the terms “including” and “comprising” are open-ended, that is, a system, device, article, or process that includes elements in addition to those listed after such a term in a claim are still deemed to fall within the scope of that claim. Moreover, in the following claims, the terms “first,” “second,” and “third,” etc. are used merely as labels, and are not intended to impose numerical requirements on their objects. The Abstract of the Disclosure is provided to comply with 37 C.F.R. § 1.72(b), requiring an abstract that will allow the reader to quickly ascertain the nature of the technical disclosure. It is submitted with the understanding that it will not be used to interpret or limit the scope or meaning of the claims. In addition, in the foregoing Detailed Description, various features may be grouped together to streamline the disclosure. This method of disclosure is not to be interpreted as reflecting an intention that the claimed embodiments require more features than are expressly recited in each claim. Rather, as the following claims reflect, inventive subject matter may lie in less than all features of a single disclosed embodiment. Thus, the following claims are hereby incorporated into the Detailed Description, with each claim standing on its own as a separate embodiment.

What is claimed is:

1. A method for automating business intelligence, comprising:
capturing data from one or more business operational data sources;
extracting signals from one or more unstructured data sources;
generating one or more metrics from the operational data and unstructured data sources;
identifying one or more anomalies from the metrics; and
suggesting predetermined courses of action and estimated financial impact.

2. The method of claim 1, comprising generating alerts on one or more opportunities.

3. The method of claim 1, comprising predicting a customer need based on the extracted signals.

4. The method of claim 1, comprising identifying anomalies in customer data and trends that present opportunities and suggesting predetermined optimal courses of action with estimated financial impact.

5. The method of claim 1, comprising determining one or more customer purchase trends, one or more products with sales exceeding a threshold, one or more opportunities to pursue, and when to contact customers.

6. The method of claim 1, comprising:
ingesting raw data from a client and from external sources and
applying transformers convert the data into a schema.

7. The method of claim 7, wherein the transformers are trained on related search term metrics, seasonality metrics, aggregated sales metrics, price metrics, channel conversion metrics, grow metrics and sales metrics.
comprising analyzing internal systems used by retailers to see what data they store.

8. The method of claim 1, comprising analyzing use cases from data science to determine data to capture.

9. The method of claim 1, comprising identifying patterns in macro trends and behavioral shifts to predict behavior and to forecast occurrence.

10. The method of claim 1, comprising detecting anomalies by observing irregular abrupt unexpected or inexplicable variations in metrics from normal.

11. The method of claim 1, comprising detecting anomalies by identification of unusual values in time series data time sequence data.

12. The method of claim 1, comprising performing statistical forecasting statistical forecasting and generating inferences about future events based on past events.

13. The method of claim 1, comprising capturing data from a plurality of data sources; storing the data in an internal schema; comparing the data to one or more metrics; and generating one or more insights from the data.

14. The method of claim 13, comprising executing insights by with a one-click integration with an application program interface.

15. The method of claim 13, comprising snoozing the insight for a future response.

16. The method of claim 1, comprising generating one or more section cards that showcase data for a conclusion and contextual information about the conclusion.

17. The method of claim 16, wherein the section cards use thresholds and numbers from anomaly metrics.

18. The method of claim 16, comprising generating an insight script on a type of insight for all products in a group.

19. The method of claim 1, comprising executing insight files with logic to generate a narrative for the insight and action to be taken, and calculating an incremental revenue generated if a recommended action is taken, and wherein each insight type is sorted by an incremental revenue, and wherein a master insight controller picks the insights to show in a round robin fashion and pushes the payload to a database to track insights shown to a user.

20. A method, comprising:
capturing data from one or more business operational data sources;
extracting signals from one or more unstructured data sources;
automatically associating a product or a service with external content by:
characterizing the product from unstructured data sources including a product text or text from similar products;
generating a label for the product or service;
applying the label as a search engine;
extracting signals relating to the product or service;
adding data from a customer review by:
extracting product categories and predicates from the customer review;
extracting product features from the customer review;
extracting an activity with the product features from the customer review;
performing sentiment analysis using a learning machine on the customer review;
determining a life scene from the customer review; and
analyzing a customer opinion from the customer review;
generating one or more metrics from the operational data and unstructured data sources;
identifying one or more anomalies from the metrics; and
suggesting predetermined courses of action and estimated financial impact.
